(19) United States
(12) Patent Application Publication
(10) Pub. No.: US 2019/0087880 A1
(43) Pub. Date: Mar. 21, 2019

(54) SYSTEM FOR REAL TIME AUTOMATED MARKET PROCESSING

(71) Applicant: Daniel William Moffatt, Edina, MN (US)

(72) Inventor: Daniel William Moffatt, Edina, MN (US)

(21) Appl. No.: 15/707,088

(22) Filed: Sep. 18, 2017

(51) Int. Cl. G06Q 30/06

(52) U.S. Cl. CPC G06Q 30/0605

(57) ABSTRACT

The present invention is a system and method for real time automated market order processing. More specifically, the present invention supports the registration of non-investment items such as digital rights, goods or services for automated pricing in a real time automated trading exchange. Hence, marketers may use the system as an alternative to fixed or bid pricing through traditional online, retail outlets or classified marketing resources. Further, consumers may use the system as an alternative to traditional means of purchasing through the advantages of market pricing subject to supply and demand conditions.

### CROSS-REFERENCE TO RELATED APPLICATION(S)

This application claims the benefit of U.S. Provisional Application No. 62/396,878 filed Sep. 20, 2016, the contents all of which are incorporated by reference.

### TECHNICAL FIELD

This invention relates to the field of exchange order processing. More specifically, the system herein describes the automated processing and settlement of real time orders at a calculated real time market price determined by variable market conditions, time horizon and supply and demand forces.

### BACKGROUND OF THE INVENTION

Currently, active real time markets are limited to investment securities where individuals buy and sell registered investments. Investment securities exchanges employ supply and demand principles along with other factors to determine an equitable price between buyer and seller. The securities traded have several forms, equities, fixed income, options, indexes, mutual funds or other. In general, securities that trade on on exchanges have a fixed number of outstanding shares, hence supply and demand market forces can be used to determine the increase or decrease in the current trade price. However, investment securities exchanges are limited to only registered securities that comply with standards of their governing bodies and provide no access to any other type of issue. Therefore, they are closed to non-investment instrument or any product, service or item that does not meet current exchange requirements.

For example, the purchase of a motion picture in the form of a DVD essentially allows the purchaser the right to view the video and sound content for their own personal use. There is no restriction on the number of times the content be viewed, nor is there a restriction of how many people can view the content as long as there is no compensation received for the viewing. Assuming the content is not available through a video streaming service, when the complete supply of new DVD pressings have been purchased, a fix number of copies, or a fixed number of purchased rights will be in circulation. Depending on the number of rights in circulation and the demand for the right to view, a natural secondary market valuation can be made for the outstanding rights in circulation. The value of a digital right such as this has market value. However, no real time trading exchange with automated pricing exists for holders of such rights.

Today, the secondary market; a market for items after the initial purchase, is essentially transacted through online marketers. Sellers list their item(s) and either designate a specific asking price or it is subject to auction. There is no exchange pricing available where a formal individual price evaluation is determined for a particular item based on supply and demand forces. Rather, the price is set by the seller typically with respect to other similar products priced in the market or set by the highest bidder with a fixed expiration. Sellers do not have a free and open trading exchange in which pure market forces determine price.

This invention however, offers an alternative real time exchange market place for both initial sales and secondary market transactions. Rather than listing their fixed priced items with traditional outlets, marketers can create, control and register their goods and services for dynamic and automated pricing on a real time automated trading exchange.

Furthermore, unlike existing marketing options, this market place allows marketers flexibility in configuring when and how their product will be released and actively trade in the exchange. These controls offer tools to assist marketers in optimizing strategies to maximize the return on their products in an efficient pricing environment. Additionally, this market place offers query tools and statistics for both marketers and consumers to optimize the market place.

Consequently, there is a need in the art for a dynamic, real time automated market processing system that provides trading exchange access to marketers of various product types. Further, there is a need to offer the advantages of determining the optimum price for non-investment items through an active exchange that employs the nature of market supply and demand forces.

### BRIEF SUMMARY OF THE INVENTION

The present disclosure, in one embodiment, relates to the process to define, configure and distribute non-investment items in a real time, computer automated trading exchange. A marketer, or issuer, issues digital rights allowing users to consume the content subject to terms and conditions set forth in a terms of use purchase agreement. The issuer may determine a fixed number of rights available for trading or allow an unlimited number of rights at a fixed price. A fixed number of rights issue is subject to real time pricing with respect to current market conditions while issues with unlimited rights distribution do not. Items registered with the exchange may trade indefinitely or trade for a limited length of time as determined by the issuer. In the case of issuing a fixed number of rights, the issuer must also set an initial price. The initial price serves as the trading price until all of right have been purchased. Thereafter, the price is subject to the automated market pricing in a secondary market.

The present disclosure, in one embodiment relates to a four component processing system: client applications, a network, web services and a database. The client applications may operate on various computer operating systems and on various device hardware platforms, but must support network communication. The client applications provide complete communication for both consumer and marketer. The network may be the world wide web or any public network communication link. The web services provide an interface for the client applications; supporting the registration of items for the exchange, access to market item information and statistics, order processing, item price determination, analytics, activity history archiving and support for all access to system information. The database serves as a repository for all supporting information.

The present disclosure, in one embodiment relates to the market price method. This method considers many factors to determine the real time trading price. The primary factors are: number of buy orders, number of sell orders, number of buy orders at a specific price, the number of sell orders at a specific price, trading velocity, total number of rights in circulation and time to target price horizon. These factors are used to determine a new target price and a point in the future when the target price will be realized. After the target price is determined, an initial increment or decrement in the price is calculated and becomes the immediate current price. This is followed by linear price changes to the target price at a future horizon time.

In another embodiment of the present disclosure, marketers may aggregate multiple items into a single item to be traded independently on the exchange. The pricing of an aggregate item or bundle that contains sub-items are priced independently and not priced as the sum of the underlying sub-items.

In another embodiment of the present disclosure, the holder of a right related to a product or service item may have the option to execute the right and take possession of the underlying physical item or receive the underlying service. When a consumer executes a right it is removed from the outstanding actively traded right for that product or service.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed descriptions are to be regarded as illustrative in nature and not restrictive.

### BRIEF DESCRIPTION OF THE DRAWINGS

FIG. 1 illustrates the network architecture and communication flow.

FIG. 2 illustrates the item pricing method

FIG. 3 illustrates the time price horizon

FIG. 4 illustrates the trade settlement flow

### DETAILED DESCRIPTION OF THE PREFERRED EMBODIMENT

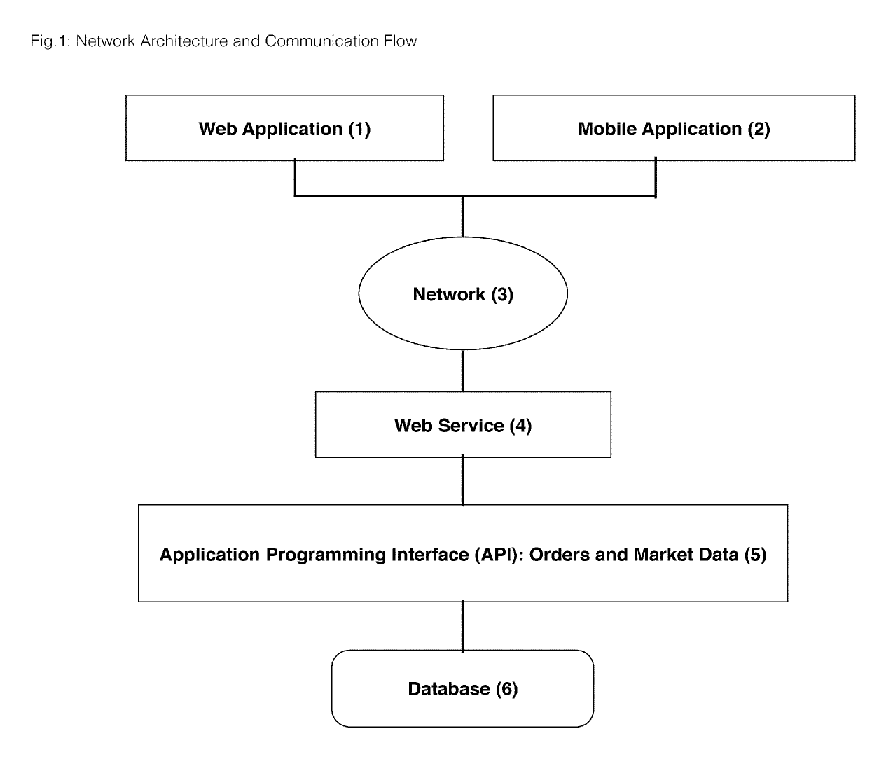

FIG. 1 shows the network architecture and communication flow of the system. The web application (1) and mobile application (2) provide the user interface and functionality to enter orders and receive trading information over the network (3). The web service (4) receives requests to enter orders and retrieve market data granting access to the application programming interface (5), or API. The API (5) is a collection of routines, scripts and/or functions that execute tasks and accesses the database (6) as needed to support the received requests originating from the client applications; web application (1) or mobile application (2). In the case of retrieving market data, supporting API (5) routines perform queries of the database (6) to obtain the requested information from the client applications (1,2).

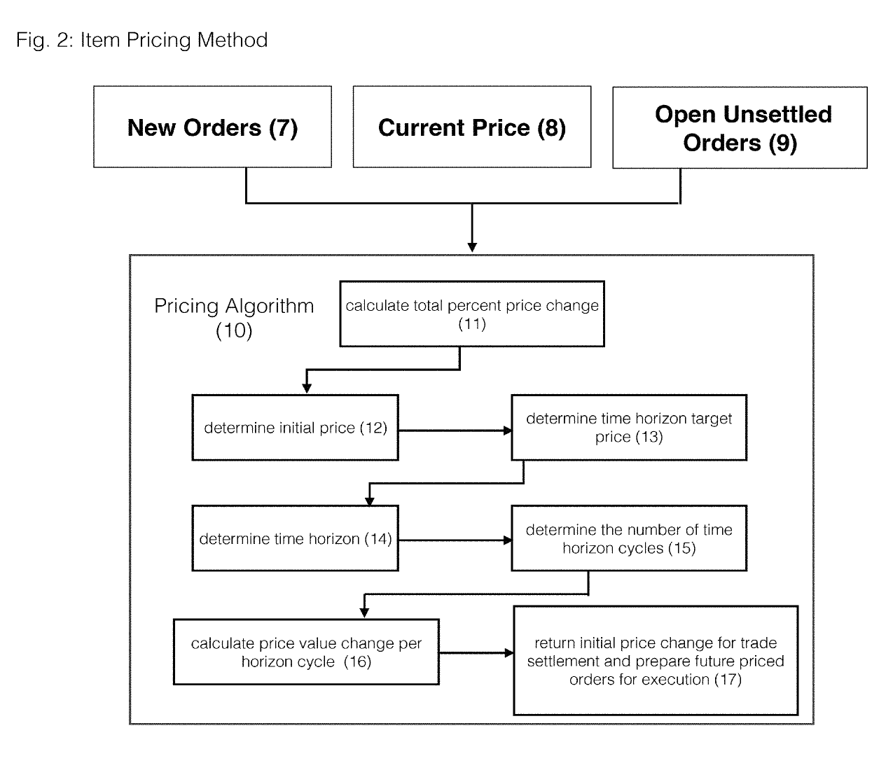

FIG. 2 shows the item pricing method within the system. When new orders (7) are sent from the client applications (1,2) through the network (3), web service (4) and received by the API (5), the current price (8) and existing open unsettled orders (9) are retrieved from the database (5). The open unsettled orders (9) exist either due to an imbalance between previous buy and sell order processing or due to a requested buy or sell price that is different than the last trading price. The new orders (7), the current price (8) and open unsettled orders (9) are passed to a pricing algorithm (10). The pricing algorithm (10) first performs a sequence of calculations to determine a new initial price (12) and its respective future horizon target price (13). The pricing algorithm (10) first calculates the total percent price change (11). The total percent price change (11) is determined by the number of buy orders minus the number of sell orders divided by a denominator. The denominator used in this equation is represented by either the number of buy orders or if there are no buy orders, the number of sell orders multiplied by a buy anticipation factor. The total percent price change (11) is the total price change realized over the time horizon (14). The next calculation is the initial price change (12). The initial price change (12) is equal to the current price (8) plus a percentage of the total percent price change (11). The percentage of the total percent price change (11) used is variable but never exceeds 25%. The time horizon target price (13) is then calculated as the last trading, or current price (8) is multiplied by 1 plus the total percent price change (11). The time horizon target price (13) is realized at the expiration of the time horizon (14). The time horizon (14) is determined by the following formula:

MINIMUM TIME HORIZON+(DIFFERENCE BETWEEN MINIMUM AND MAXIMUM TIME HORIZON)/(AVERAGE ORDERS PER MINUTE/MAXIMUM ORDERS PER MINUTE)

The minimum and maximum time horizon values used in the above equation are system defined constants whereas the average orders per minute and maximum orders per minute are inferred from trading activity. The number of time horizon cycles (15) is the number of time intervals between the time of the pricing method execution and the future calculated time horizon (14). These intervals are determined by trading volume of the underlying item. The maximum cycles per minute is a system constant defined 60. Whereas the minimum is a system defined constant 0.2. The price value change per horizon cycle (16) can then be determined and provides a price change continuum for prices changes over time. The item pricing method returns the initial price change (17) which represents the newly calculated current trading price.

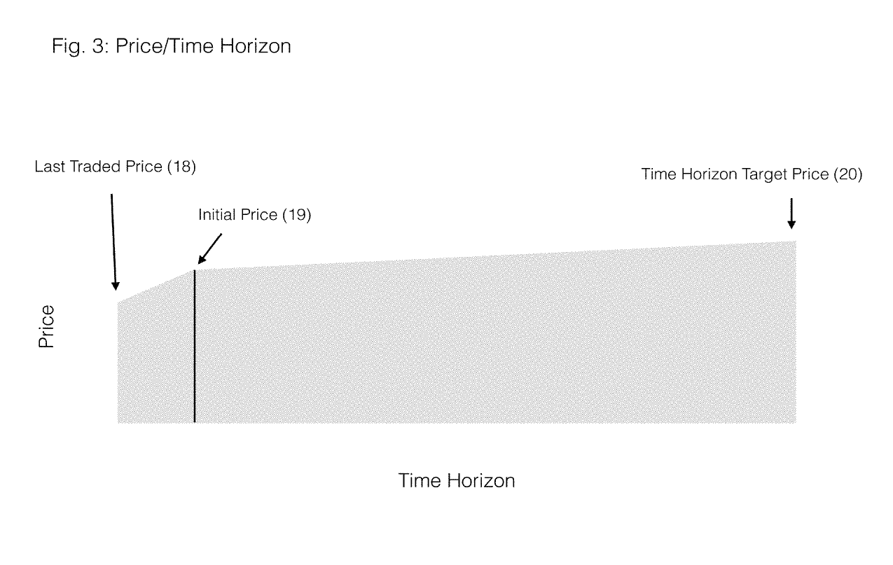

FIG. 3 Price/Time Horizon illustrates the initial price (19) calculated from the last traded price (18) and the subsequent linear incremental price changes that occur between the initial price (19) and the time horizon target price (20). This linear price change illustration remains active until either a new order is submitted for execution, a priced order is executed that plots between the initial price (19) and the time horizon target price (20) or the time horizon (14) is reached whereby the item price method is executed to recalculate a new time horizon target price (13) and time horizon (14).

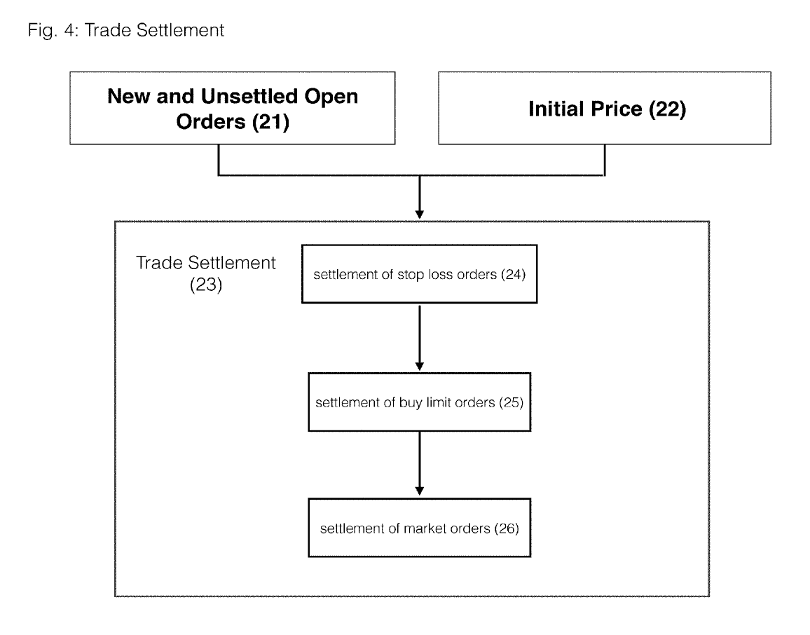

FIG. 4 Trade Settlement illustrates the order of trade settlement by the trade settlement (23) function. New and unsettled open orders (21) and the initial price (22) are passed to the trade settlement (23) function. The trade settlement (23) first determines which existing stop loss orders are valid for execution with respect to the passed initial price (22). The settlement of valid stop loss orders (24) are first matched with valid open buy limit orders. The settlement price for these trades are determined by the stop loss price. The trade settlement (23) secondarily settles any remaining valid buy limit orders. The settlement of buy limit orders (25) are then matched with the available market sell orders at a price determined by the respective matching buy limit order. The final settlement is the settlement of market orders (26). The settlement of market orders (26) are the remaining open orders to be settled at the initial price (22) after the settlement of stop loss orders (24) or settlement of buy limit orders (25) have been executed.

1. A system for real time automated market processing comprising:
client applications:
a web application containing:
a user interface to enter orders and receive market information
a mobile application containing:
a user interface to enter orders and receive market information a public network;
a web service including:
an application programming interface containing:
functionality that support the exchange of orders and market information;
database storage and access;
a database;

2. The parts of claim 1 wherein the said web service includes said application programming interface whereby said functionality facilitates:
user registration;
order entry in a real time trading exchange;
trading support for the exchange of various types of goods, services and/or rights;
market data queries.

3. The parts of claim 2 wherein the said order entry in a real time trading exchange functionality passes the current price and new and existing unsettled orders to a pricing algorithm that performs the following functions:
calculation of the total percent price change based on open buy and sell orders;
calculation of an initial price;
calculation of a time horizon target price;
calculation of a time horizon;
calculation of the number of horizon cycles in the time horizon;
calculation of the price value change per horizon cycle.

4. The parts of claim 3 wherein the said calculation of total percent price change based on buy and sell orders consists of subtracting the said open sell orders from said open buy orders divided by a denominator represented by either the number of said open buy orders or if zero, the number of said open sell orders multiplied by a predetermined factor representing a propensity to buy from the resulting price from said pricing algorithm. The said open sell orders and said open buy orders consist of orders to be executed at the price determined by the said pricing algorithm or orders that specifies a price that qualifies the order for settlement. Formula: TPPC=(NumBO−NumSO)/NumBO (or NumSO×propensity to buy factor).

5. The parts of claim 3 wherein the said calculation of initial price is determined by said current price plus said total percent price change based on open buy and sell orders multiplied by a predetermined factor. Formula: IP=CP+(TPPC×PreDeterminedFactor).

6. The parts of claim 3 wherein the said calculation of a time horizon target price is determined by multiplying the said current price by one plus said total percent price change based on qualifying buy and sell orders. Formula: THTP=CP×(1+TPPC).

7. The parts of claim 3 wherein the said calculation of time horizon is determined by a predetermined minimum time horizon plus the difference between a predetermined maximum time horizon and predetermined minimum time horizon divided by the average orders received per minute divided by a predetermined maximum number of orders per minute. Formula: TH=MinTH+((MaxTH−MinTH)/(AvgOPM/MaxOPM)).

8. The parts of claim 3 wherein the said calculation of the number of horizon cycles in the time horizon is determined by dividing the said calculation of time horizon represented in minutes by a predetermined number of cycles per minute based on trading activity for the underlying item.

9. The parts of claim 3 wherein the said calculation of the price value change per horizon cycle is determined by subtracting the said calculation of initial price from said calculation of time horizon target price divided by said calculation of the number of horizon cycles in the time horizon. Formula: PVCHC=(THTP−ITP)/NumTHC.

10. The parts of claim 2 wherein the said market data queries consist of routines that provide analysis, statistics on market activity.
